(19) United States
(12) Patent Application Publication
(10) Pub. No.: US 2013/0154989 A1
(43) Pub. Date: Jun. 20, 2013

(54) SYSTEM AND METHOD FOR TOUCH SCREEN

(71) Applicant: Robert Campbell, Sunnyvale, CA (US)

(72) Inventor: Robert Campbell, Sunnyvale, CA (US)

(73) Assignee: HEWLETT-PACKARD DEVELOPMENT COMPANY, Fort Collins, CO (US)

(21) Appl. No.: 13/818,968

(22) PCT Filed: Aug. 30, 2010
(86) PCT No.: PCT/US10/47167

§ 371 Date: Feb. 25, 2013

(51) Int. Cl. G06F 3/041

(52) U.S. Cl. CPC G06F 3/041
USPC 345/173

(57) ABSTRACT

An embodiment of the present invention provides a touch screen. The touch screen includes a touch detector configured to determine a location of an object proximate to a front surface of a screen, and a force detector configured to determine a force that the object places on the screen.

### BACKGROUND

Touch screens may use resistive, capacitive, or optical detection systems to determine the location of a contact with the touch screen. The location of the contact with the touch screen may for example select an object displayed on the touch screen.

### BRIEF DESCRIPTION OF THE DRAWINGS

Certain exemplary embodiments are described in the following detailed description and in reference to the drawings, in which:

FIGS. 1A is a drawing of a monitor having a screen with an optical detector 104 superimposed over the front surface 106, in accordance with an embodiment of the invention;

FIG. 1B is a drawing of a monitor having a screen with an optical detector superimposed around a perimeter of the screen, in accordance with an embodiment of the invention;

FIG. 2 is a block diagram of the monitor of FIG. 1, showing the functionality that may be present in embodiments of the invention;

FIG. 3 is a drawing of an all-in-one computer system in accordance with an embodiment of the invention;

FIG. 4 is a block diagram of the all-in-one computer system showing the different units that may be present in embodiments of the invention; and

FIG. 5 is a method that may be used to correlate an optical touch system with a force sensor, in accordance with an embodiment of the invention.

### DETAILED DESCRIPTION OF SPECIFIC EMBODIMENTS

An embodiment of the invention provides a touch screen that incorporates a force sensor into a base holding the screen. A touch detector may determine a location and a size of an object that is proximate to a front surface of the screen, but may not confirm an actual contact, or report the force of a contact. In embodiments, the force reported by the force sensor may be correlated with the location of the touch. As discussed herein, the correlation may be used to modify a feature of an item displayed on the screen, such as a virtual brush size, a line size, a text size, or any combinations thereof. Further, the correlation may be used in any number of other ways, for example, to allow selection of an object on different layers of a drawing based, at least in part, on the force applied to the touch screen.

As used herein, a screen is a display unit, such as a thin-film transistor liquid crystal display, that may be used to show items output by programs. A monitor is a unit that has a screen and physical and electronic structures for holding the screen in position and displaying data on the screen. An all-in-one computer will have screen built into a case that also contains a processor and other units, and which functions as a self-contained computer system.

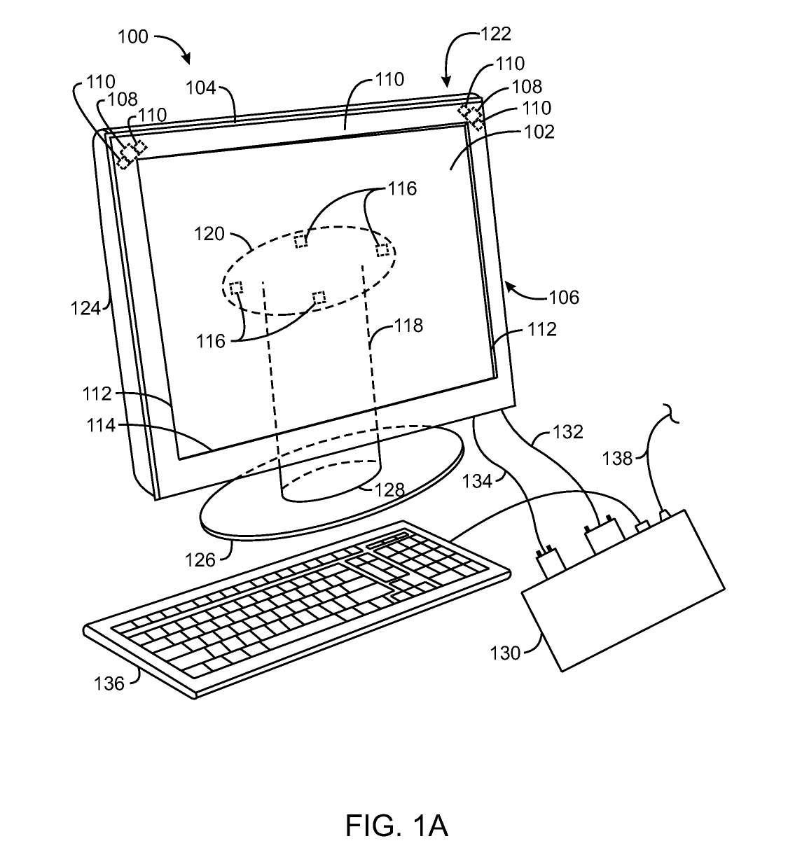

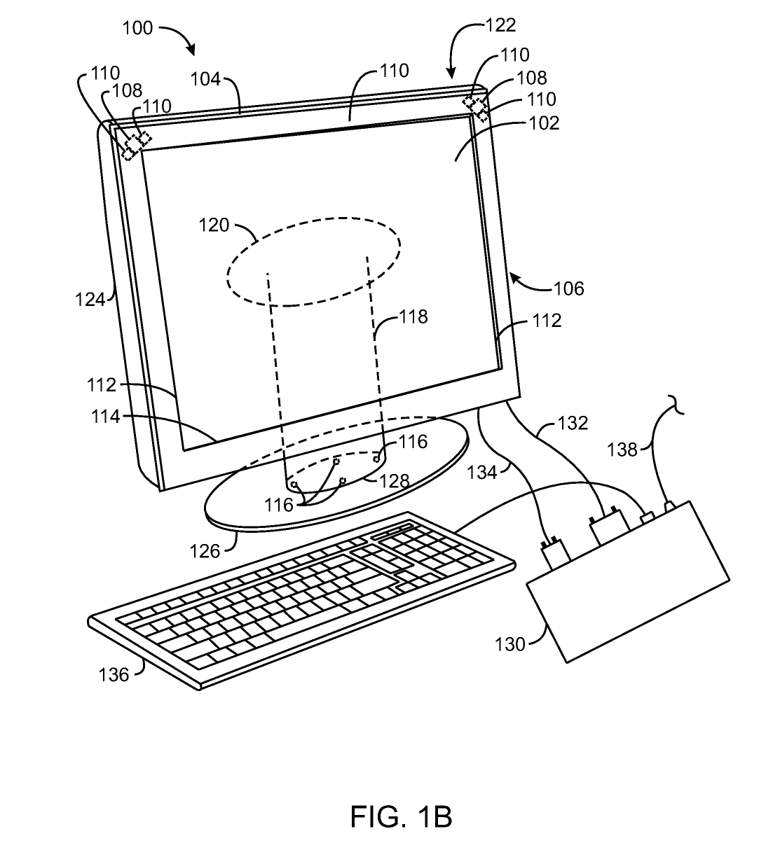

FIG. 1A is a drawing of a monitor 100 having a screen 102 with a detector 104. The detector 104 may be around a perimeter 106 of the screen 102, in accordance with an embodiment of the invention may be in front of the screen 102, or may be in another location. The detector 104 includes detectors 108 and emitters 110, which may, for example, be located in the optical detector 104 at the upper corners of the screen 102. In an embodiment, a two dimensional optical detector 104 may used in which the interior side surfaces 112 and interior bottom surface 114 of the optical detector 104 may be reflective. In this example, the emitters 110 may emit an optical signal, such as an infrared (IR) signal, either continuously or intermittently. The optical signal is reflected from the side surfaces 112 and bottom surface 114 and detected by the detectors 108. Placing an object, such as a fingertip, in proximity to the screen may reduce the intensity detected at a particular location over the screen 102, which may cause the optical detector 104 to report a touch at a set of x, y coordinates. Different thresholds may be used to determine a touch, such as a 25% reduction in light intensity, a 50% reduction, a 75% reduction, or even higher. In another embodiment, a three dimensional optical detector 104 may be used. In this example, the emitters 110 can send out a pulsed optical signal. Reflections from the optical signal are received by the detectors 108, and a time-of-flight determination between the emitted and detected pulses may be used to identify the x, y, and z coordinates of an object in proximity to the screen.

The emitters 108 and detectors 110 are not limited to the arrangements discussed above, as any number of optical detection systems may be used in embodiments of the current techniques. For example, a crossed light curtain may be used, in which a first set of emitters is placed along the bottom surface of the optical detector 104 opposite a first set of detectors along a top surface. A second set of emitters can placed at one side optical detector 104 opposite a second set of detectors. In this embodiment, the cross-configuration of the emitters and detectors creates vertical and horizontal light beams that may be used to determine a location of an object that is proximate to the front surface 106 of the screen 102, for example, by identifying which light beams are interrupted. Further, the number of interrupted beams may be used to determine the size of the object that is proximate to the front surface 106.

The monitor 100 can also have one or more force sensors 116 incorporated into the stand 118 that supports the screen 102. The force sensors 116 may be located in any number of positions in the stand 118, for example, in a bracket 120 attached to the back side 122 of the case 124 holding the screen 102. The force sensors 116 are not limited to this position and may be located in any number of other positions. For example, the force sensors 116 may be located in a pedestal 126 holding the stand 118, such as at the point 128 where the stand 118 connects to the pedestal 126. This embodiment is discussed with respect to FIG. 1B.

The monitor 100 may have a number of input and output systems for coupling to a computer system 130. For example, a video system may obtain a video signal over a video cable 132 that couples the monitor 100 to the computer system 130. A signal system may use a signal cable 134 to provide touch and/or force data to the computer system 130. For example, the signal system may be a universal serial bus (USB) system, or any number of other systems for carrying a signal from the monitor 100 to the computer system 130. In embodiments, a single cable, such as an Ethernet cable or an HDMI cable, among others, may be used to carry both signals from both systems.

Other units may be attached to the computer system 130. For example, the computer system 130 may have a keyboard 136 for entering text and commands, although the touch screen of the monitor 100 may be used for the text entry. Further, the computer system 130 may have an Ethernet, or other, network connection 138.

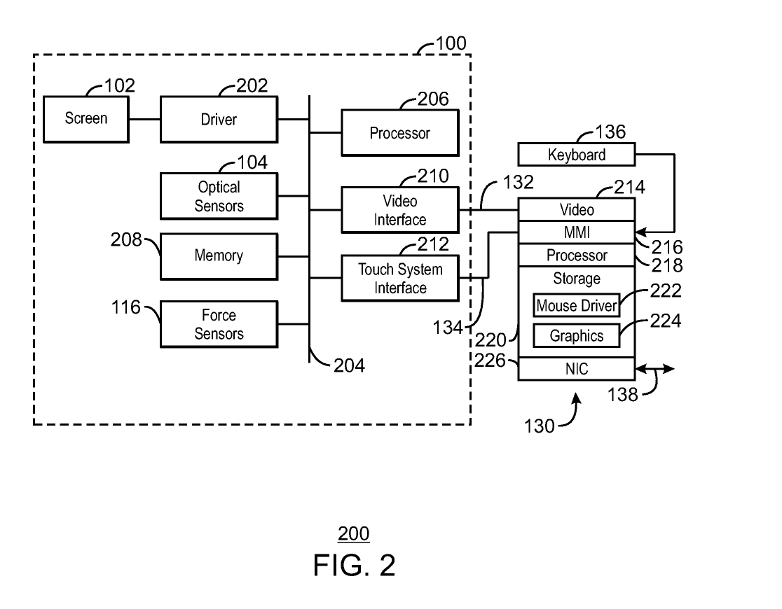

FIG. 1B is a drawing of a monitor having a screen with an optical detector superimposed around a perimeter of the screen, in accordance with an embodiment of the invention. In this embodiment, the force sensors 116 may also be located in the pedestal 126 that holds the stand 118, for example, at the point 128 where the stand 118 attaches to the pedestal 126. The force sensors 116 may be located in any number of other positions, such as underneath the pedestal. Further, the stand is not limited to attaching to the back of the monitor, but may be attached to the base of the case 124. An internal structure of the monitor 100 is discussed further with respect to FIG. 2.

FIG. 2 is a block diagram 200 of the monitor 100 of FIG. 1, showing the functionality that may be present in embodiments of the invention. As shown in the block diagram 200, the monitor 100 has a screen 102 coupled to a driver 202 that holds the circuitry needed to activate individual pixels, such as a thin-film-transistor (TFT) backplane. The driver 202 may be coupled to a bus 204 for communications with other units in the monitor 100. The monitor 100 can have a processor 206 coupled to the bus 204 to perform various functions, such as decoding video signals or determining a location of a touch or measuring a force on the screen 102. The processor 206 may access a memory 208 over the bus 204. The memory 208 may include random access memory (RAM) and read only memory (ROM), among others. The ROM may be used to store programs used by the processor 206, for example, code configured to direct the processor 206 to access the optical sensors 104 over the bus 204 and determine that an object is blocking a portion of the light beams, and is, thus, proximate to the screen 102. The ROM of the memory 208 may also be used to store code configured to direct the processor 206 to poll the force sensors 116, for example, to determine if a force has been applied to the front of the screen 102. The RAM may be used to hold intermediate results such as decoded video frames or data on horizontal and vertical light beams that are blocked, while the processor 206 uses the results to calculate a position of a proximate object. The RAM may also be used to hold values from the force sensors 116, while a corresponding location is determined from the optical sensors 104.

The monitor 100 can include a video interface 210 coupled to the bus 204. The video interface 210 may be configured to obtain video data from a computer system 130 through a video cable 132. The processor 206 may process the video information, for example, buffering it in the memory 208 before sending the video information to the driver 202 to be displayed on the screen 102. The monitor 100 may also have a touch system interface 212 coupled to the bus 204. The processor 206 may use the touch system interface 212 to transfer location and size information for objects identified from the optical sensors 104, and force information from the force sensors 116 to the computer system 130 over an interface cable 134, such as a USB cable. In an embodiment, the memory 208 includes code configured to direct the processor 206 to report a touch, for example, size and location information for an object proximate to the screen 102, only if a force greater than a threshold value is detected. For example, the monitor 100 may not locate or report a touch of less than about 0.25 N, 0.5 N, 1 N, or 5 N. In other embodiments, the monitor 100 may detect any optical disturbance using the optical sensors 104, for example, greater than about 75%, 50%, or 10% reduction in intensity of any of the light at any position over the screen 102, and report the size location, and force readings at the time the optical disturbance is detected.

In embodiments, the computer system 130 may have a number of units, including hardware and software, to facilitate the use of the location, size, and force information. For example, the computer system 130 may have a video system 214 to provide a video signal to the monitor 100 through the video cable 132. The computer system 130 may also have a man-machine interface (MMI) 216, for example, in the operating system, to receive the location information from the monitor 100 and translate the information into a pointer location. The MMI 216 may also interface to a keyboard 136 to obtain text information. The computer system 130 will have a processor 218 to operate the software and hardware modules that provide the functionality. A storage system 220 may store code modules configured to direct the processor 218 to boot and run programs, for example, that provide the functionality for embodiments of the invention. The storage system 220 may include any combination of non-transitory computer readable media, including random access memory (RAM), read only memory (ROM), hard drives, optical drives, RAM drives, flash drives, and the like. The modules may include, for example, a mouse driver 222, configured to direct the processor to use the location information from the monitor 100 to provide a mouse or pointer functionality, such as moving or selecting items shown on the screen 102. Other modules may include a graphics program 224, such as a drawing program or a computer aided design (CAD) program configured to direct the processor to modify a feature of an item shown on the screen 102 at a location determined from the optical sensors 104, based on the amount of force measured by the force sensors 116.

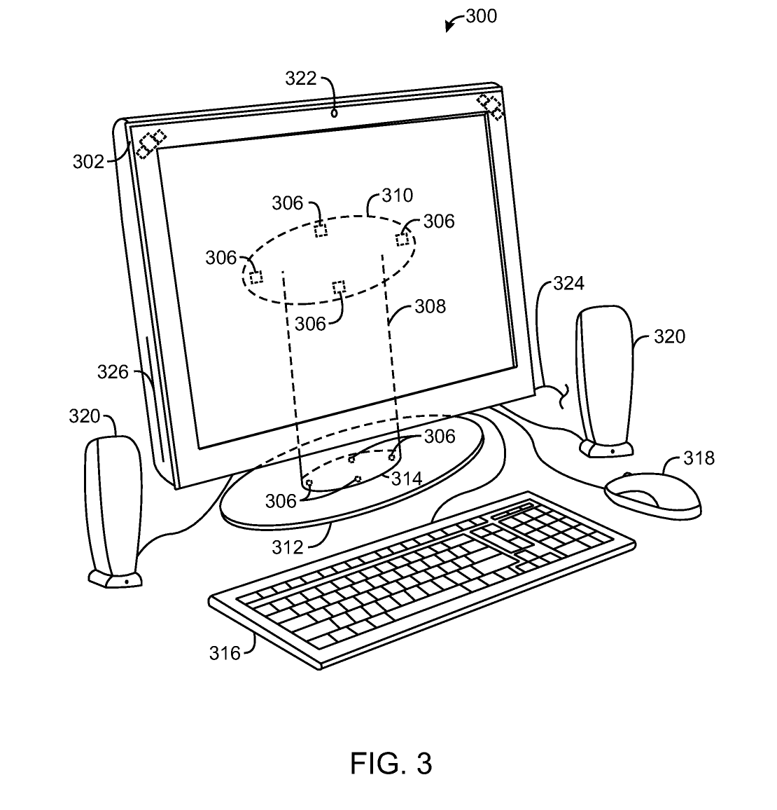

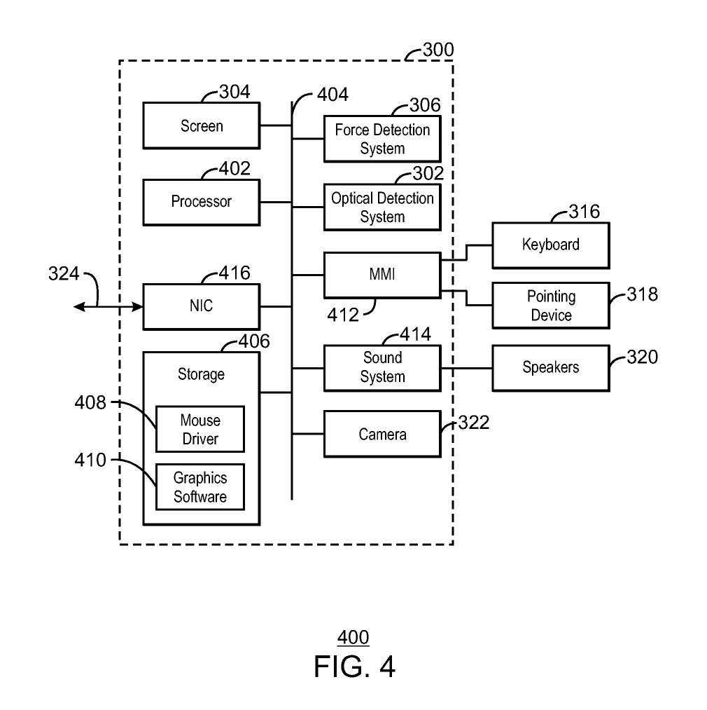

Other units may be included in the computer system 130 to provide further functionality, such as a network interface card (NIC) 226 configured to provide the computer system 130 with network access over the network cable 138. The techniques are not limited to a stand-alone monitor 100 operating with a separate computer system 130. Instead, all of the functionality described above may be included in a single all-in-one computer system, as discussed with respect to FIGS. 3 and 4.

FIG. 3 is a drawing of an all-in-one computer system 300 in accordance with an embodiment of the invention. The all-in-one computer system 300 includes an optical detection system 302 superimposed over a front surface of a screen 304. As for the monitor 100 (FIG. 1) discussed previously, the optical detection system 302 can be built into the case of the all-in-one computer system 300. The optical detection system 302 functions as described with respect to the optical detector 104 of the monitor 100. Further, force detection sensors 306 can be placed in the stand 308 holding the all-in-one computer system 300. As described with respect to the force sensors 116 for the monitor 100, the force detection sensors 306 can be placed in a bracket 310 holding the all-in-one computer system 300 to the stand 308. In embodiments, the force detection sensors 306 may be placed in the pedestal 312 at the point 314 where the stand 308 joins the pedestal 312.

The all-in-one computer system 300 will generally include numerous devices for direct input and output. For example, a keyboard 316 can be attached to allow for entering text and commands. In an embodiment, the keyboard 316 can be omitted in favor of an on-screen keyboard that uses the optical detection system 302 for data entry. The all-in-one computer system 300 may also include a separate pointing device, such as a mouse 318, although this may be left off and the touch screen may be used for selection of items shown on the screen 304. The all-in-one computer system 300 may include speakers 320, a camera 322, a network interface 324, drives 326, or any number of other devices.

FIG. 4 is a block diagram 400 of the all-in-one computer system 300 showing the different units that may be present in embodiments of the invention. In an embodiment, a processor 402 may communicate with various units over a bus 404, such as a screen 304. As shown, the screen 304 includes both the driver electronics and the screen. The processor 402 may also monitor the optical detection system 302 and the force detection system 306 over the bus 404.

A storage system 406 may be used to hold operating programs for the all-in-one computer system 400, such as programs to boot the all-in-one computer system 300 and programs to implement embodiments of the invention. The storage system 406 may include any combination of non-transitory computer readable media, including random access memory (RAM), read only memory (ROM), hard drives, optical drives, RAM drives, flash drives, and the like. The storage system 406 may include code configured to direct the processor 402 to access the optical detection system 302 over the bus 404 and determine that an object is blocking a portion of the light beams, and is, thus, proximate to the screen 304. The storage system 406 may also hold store code configured to direct the processor 402 to poll the force detection system 306, for example, to determine if a force has been applied to the front of the screen 304.

In an embodiment, the storage system 406 includes code configured to direct the processor 402 to report a touch, for example, size and location information for an object proximate to the screen 304, only if a force greater than a threshold value is detected. For example, a touch of less than about 0.1 N, 0.25 N, 0.5 N, 1 N, or 5 N may not be recognized or used by the all-in-one computer system 300. In other embodiments, the all-in-one computer system 300 may detect any optical disturbance using the optical detection system 302, with or without a simultaneously applied force, and provide the size, location, and force readings to applications. For example, a mouse driver 408 may use the location information to show a pointer icon on the screen 304 at the detected location. In embodiments, the pointer icon may only be shown when the force reading is above the threshold value, as discussed above.

Other applications, such as graphics software 410, may use both the location and the force to change a feature of an item shown on the screen, based, at least in part, on the size, the location, or the force, or any combinations thereof. For example, the applications may change a virtual brush size, a line size, a text size, or any combinations thereof. Further, applications may use the force entry to simulate real word physics. In this embodiment, an application may allow selection of an object in a displayed layer, based, at least in part, on the force applied to the screen. As used herein, a layer may correspond to an item, or group of items, displayed on a screen. In various applications, the items may be overlapping. Selecting different layers on the screen selects which items may be affected by an input. Different ranges of force may be assigned to different layers, with lower force ranges assigned to higher layers. As an example, the force ranges may be about 0.1 to 0.25 N for a top layer, about 0.5 to 1 N for a middle layer, and about 1.5 to 2 N for a bottom layer. It will be apparent that these ranges and layers are not limiting, but that any number of possible different force ranges may be used.

The all-in-one computer system 300 may include other units to perform different functions. For example, a man-machine interface 412 may be included to interface to a keyboard 316 or an external pointing device 320, if desired. Further, a sound system 414 may be used to drive speakers 320 or headphones. In addition, a network interface card (NIC) 416 may be used to provide network access to the all-in-one computer system 300 over a network cable 324, wireless network adapter, or other device.

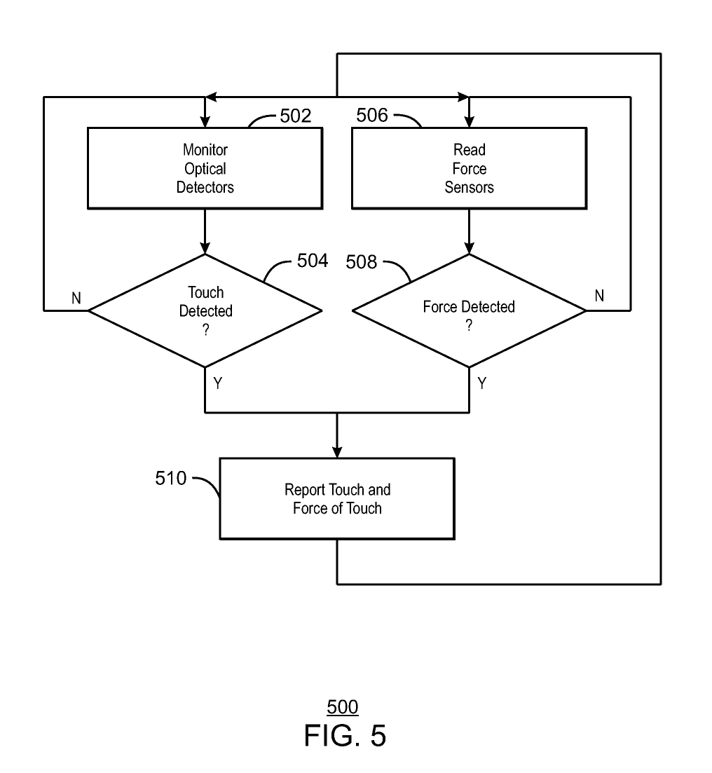

FIG. 5 is a method 500 that may be used to correlate an optical touch system with a force sensor, in accordance with an embodiment of the invention. The method 500 begins at block 502 with a processor monitoring the optical detectors for an optical disturbance. The optical disturbance may be, for example, a decrease in light intensity of one or more light beams in a detector array. At block 504, a determination is made as to whether an optical disturbance represents a touch. For example, using a two-dimensional optical detector, a threshold may be selected to initiate the detection of the touch, such as a 75%, 50%, or 25% decrease in light intensity at a location over the screen. Using a three-dimensional optical detector, a proximate location between an object and a screen location may represent a touch, such as 1 millimeter (mm) from the screen, 2 mm from the screen, or any other location. If no touch is detected, process flow may return to block 502 to continue monitoring. The force sensors can be monitored in parallel to the optical detection, as indicated at block 506. If no force has been detected at block 510, the process may return to block 506 to continue monitoring the force sensors. In this embodiment, a first set of memory locations may represent flags that may be set to indicate that new values for optical or force measurements have been detected, while a second set of memory locations may hold the last values detected for location, size, and force.

In an embodiment, if a touch is detected by both the optical sensors and the force sensors, at block 510, the location, force, and size of the touch may be reported or registered by the system. The process then returns to blocks 502 and 506 to continue monitoring the optical detectors and force sensors. In some embodiments, a force is applied to the screen before a touch is registered at the location defined by the optical detector.

An application may use the location, force, and/or size to control a function, as discussed with respect to FIG. 4. For example, in an embodiment, a virtual brush may be displayed on the screen at the reported location. The size of the virtual brush that is displayed may be controlled by the force of the touch, the size of the object touching the screen, or both. The applications of the monitor and the all-in-one computer system are not limited to those discussed above, as any number of other possible applications may be created.

What is claimed is:

1. A touch input system, comprising:
a screen;
a stand attached to a case holding the screen;
a detector is configured to determine a location of an object proximate to the front surface of the screen; and
a force sensor disposed proximately to the stand, wherein the force sensor is configured to determine a force that the object places on the screen.

2. The touch input system of claim 1, comprising an all-in-one computer.

3. The touch input system of claim 1, comprising a monitor.

4. The touch input system of claim 3, comprising a force sensor system configured to report the force to an external computer system.

5. The touch input system of claim 3, comprising a signal system to report the location, the force, or both to the computer system.

6. The touch input system of claim 5, wherein the signal system comprises a universal serial bus (USB) system.

7. The touch screen system of claim 1, comprising:
a processor; and
a storage system comprising code configured to direct the processor to display an item on the screen at the location of the object.

8. The touch screen system of claim 7, wherein the storage system comprises code configured to size the item based, at least in part, on the force applied to the screen.

9. The touch screen system of claim 7, wherein the storage system comprises code configured to direct the processor to register a touch on the screen at the location of the object once a force is detected.

10. A method for operating a touch screen system, comprising:
monitoring a touch detector to determine a location of an object proximate to a front surface of a screen; and
measuring a force that the object places on the screen by reading a force sensor in a stand supporting the touch screen system.

11. The method of claim 10, comprising confirming that the object is touching the screen based, at least in part, on the force.

12. The method of claim 10, comprising changing a feature of an item shown on the screen, based, at least in part, on the size, the location, or the force, or any combinations thereof.

13. The method of claim 12, wherein the feature is a virtual brush size, a line size, a text size, or any combinations thereof.

14. The method of claim 12, wherein the feature is an item on a layer selected based, at least in part, on the force applied to the screen.

15. The method of claim 10, comprising changing an operation of a program, based, at least in part, on a size, the location, or the force, or any combinations thereof.
